(19) United States
(12) Patent Application Publication
(10) Pub. No.: US 2009/0002337 A1
(43) Pub. Date: Jan. 1, 2009

(54) Capacitive-type touch panel

(75) Inventor: Yu-Huei Chang, Sijhih City (TW)

Correspondence Address: Shirley L. Church, Esq., P.O. Box 81146, San Diego, CA, 92138, US

(73) Assignee: Sense Pad Tech Co., LTD

(21) Appl. No.: 12/152,714

(22) Filed: May 16, 2008

(30) Foreign Application Priority Data
Jun. 28, 2007 (TW) 096123484

(51) Int. Cl. G06F 3/045

(52) U.S. Cl. 345/174

(57) ABSTRACT

A capacitive-type touch panel includes: a transparent substrate; a plurality of first conductors; a plurality of second conductors cooperating with the first conductors to form a matrix of capacitive regions; and a controller connected electrically to the first and second conductors for detecting the capacitance of each of the capacitive regions. Each of the first conductors is intersected and divided by the second conductors into a series of first electrode sections. Each of the second conductors is intersected and divided by the first conductors into a series of second electrode sections. Each of the first and second electrode sections of the first and second conductors has a fine conductor line-constructed structure which is constructed from a fine line-shaped conductor.

### CROSS-REFERENCE TO RELATED APPLICATION

This application claims priority of Taiwanese Application No. 096123484, filed on Jun. 28, 2007.

### BACKGROUND OF THE INVENTION

1. Field of the Invention

This invention relates to a capacitive-type touch panel, more particularly to a capacitive-type touch panel including first and second conductors having sections, each having a fine conductor line-constructed structure.

2. Description of the Related Art

FIG. 1 illustrates a conventional capacitive-type touch panel that includes a transparent substrate 11, a first electrode unit 12 formed on a top surface of the transparent substrate 11, a second electrode unit 13 formed on a bottom surface of the transparent substrate 11, a conductive first connecting line unit 15 connected to the first electrode unit 12, a conductive second connecting line unit 16 connected to the second electrode unit 13, and a controller 14 connected to the first and second connecting line units 15, 16.

FIG. 2 illustrates another conventional capacitive-type touch panel that includes a transparent substrate 21, a first electrode unit 22 formed on a top surface of the transparent substrate 21, an insulator layer 24 disposed on the first electrode unit 22, and a second electrode unit 23 formed on a top surface of the insulator layer 24.

When the aforesaid conventional capacitive-type touch panels are activated, an electric field distribution is generated between the first and second electrode units 12, 13 (22, 23). At this time, when the user operably touches the capacitive-type touch panel at one location, the electric field at the location is changed, which results in a change in the capacitance between the first and second electrode units 12, 13 (22, 23) at the location, thereby permitting identification of the coordinates of the location through the controller 14.

Since the first and second electrode units 12, 13 (22, 23) of the aforesaid conventional capacitive-type touch panels are made from a transparent conductive material, such as indium tin oxide (ITO), which has a much higher sheet resistance compared to those of metals, such as Cu, Ag and Au, the sheet resistance of the conventional capacitive-type touch panels will be larger than 1KΩ/square and the capacitance of the conventional capacitive-type touch panels from one peripheral end to an opposite peripheral end will be larger than 400 pF (pico-farad) when the capacitive-type touch panel has dimensions larger than 7×7 inches, which can result in relatively poor identification of coordinates of a location touched by the user, which, in turn, limits production of larger sizes of the capacitive-type touch panels.

### SUMMARY OF THE INVENTION

An object of the present invention is to provide a capacitive-type touch panel that can overcome the aforesaid drawbacks associated with the prior art.

According to this invention, there is provided a capacitive-type touch panel that comprises: a transparent substrate; a plurality of first conductors disposed on the transparent substrate; a plurality of second conductors disposed on the transparent substrate, intersecting insulatively with the first conductors, and cooperating with the first conductors to form a matrix of capacitive regions when a current is applied to the first and second conductors; and a controller connected electrically to the first and second conductors for detecting the capacitance of each of the capacitive regions. Each of the first conductors is intersected and divided by the second conductors into a series of first electrode sections. Each of the second conductors is intersected and divided by the first conductors into a series of second electrode sections. Each of the first and second electrode sections of the first and second conductors has a fine conductor line-constructed structure which is constructed from a fine line-shaped conductor.

### BRIEF DESCRIPTION OF THE DRAWING

Other features and advantages of the present invention will become apparent in the following detailed description of the preferred embodiments of this invention, with reference to the accompanying drawings, in which:

FIG. 1 is a fragmentary schematic view of a conventional capacitive-type touch panel;

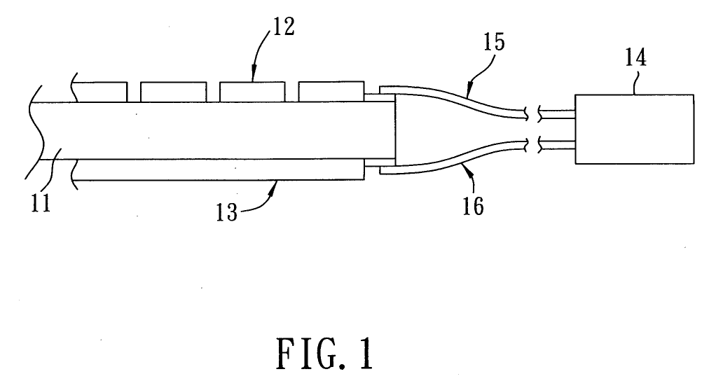

FIG. 2 is a partly exploded schematic view of another conventional capacitive-type touch panel;

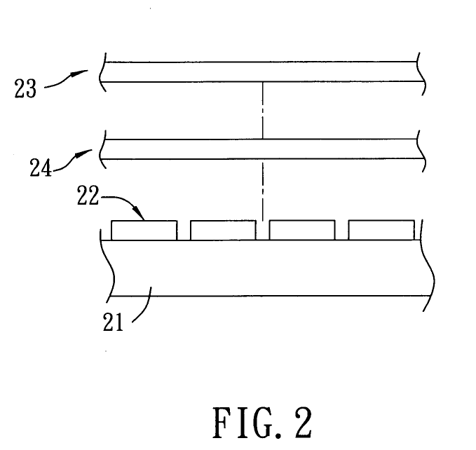

FIG. 3 is a cutaway perspective view of the first preferred embodiment of a capacitive-type touch panel for mounting to a display according to this invention;

FIG. 4 is a fragmentary schematic view of the first preferred embodiment according to this invention;

FIG. 5 is a fragmentary perspective view of the first preferred embodiment;

FIG. 6 is a fragmentary perspective view of the second preferred embodiment of the capacitive-type touch panel according to this invention;

FIG. 7 is a fragmentary schematic view of the third preferred embodiment of the capacitive-type touch panel according to this invention;

FIG. 8 is a fragmentary perspective view of the third preferred embodiment;

FIG. 9 is a fragmentary schematic view of the fourth preferred embodiment of the capacitive-type touch panel according to this invention;

FIG. 10 is a fragmentary perspective view of the fourth preferred embodiment;

FIG. 11 is a fragmentary sectional view taken along line XI-XI of FIG. 9;

FIG. 12 is a fragmentary perspective view of the fifth preferred embodiment of the capacitive-type touch panel according to this invention;

FIG. 13 is a fragmentary schematic view of the sixth preferred embodiment of the capacitive-type touch panel according to this invention;

FIG. 14 is a fragmentary partly sectional cutaway perspective view of the sixth preferred embodiment;

FIG. 15 is a fragmentary sectional view of the sixth preferred embodiment;

FIG. 16 is a fragmentary, exploded perspective view of the seventh preferred embodiment of the capacitive-type touch panel according to this invention; and

FIG. 17 is a fragmentary, exploded perspective view of the eighth preferred embodiment of the capacitive-type touch panel according to this invention.

### DETAILED DESCRIPTION OF THE PREFERRED EMBODIMENTS

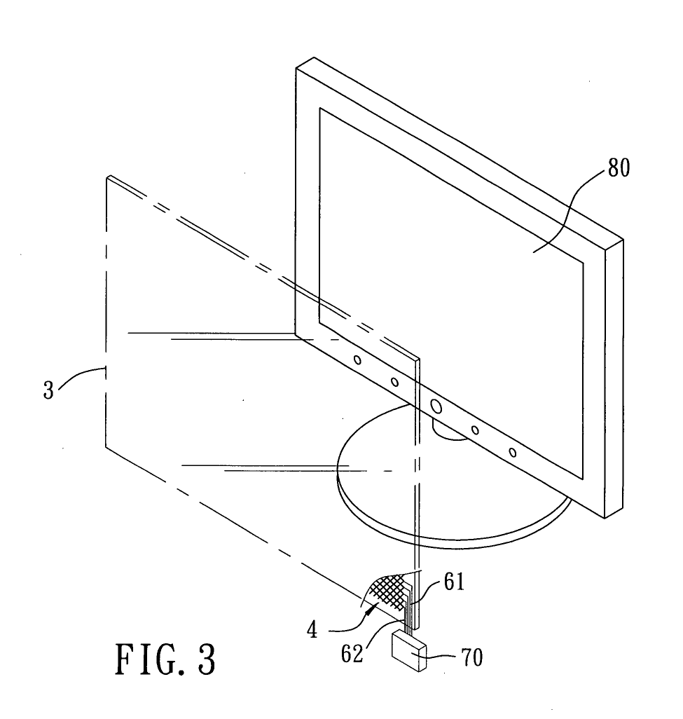

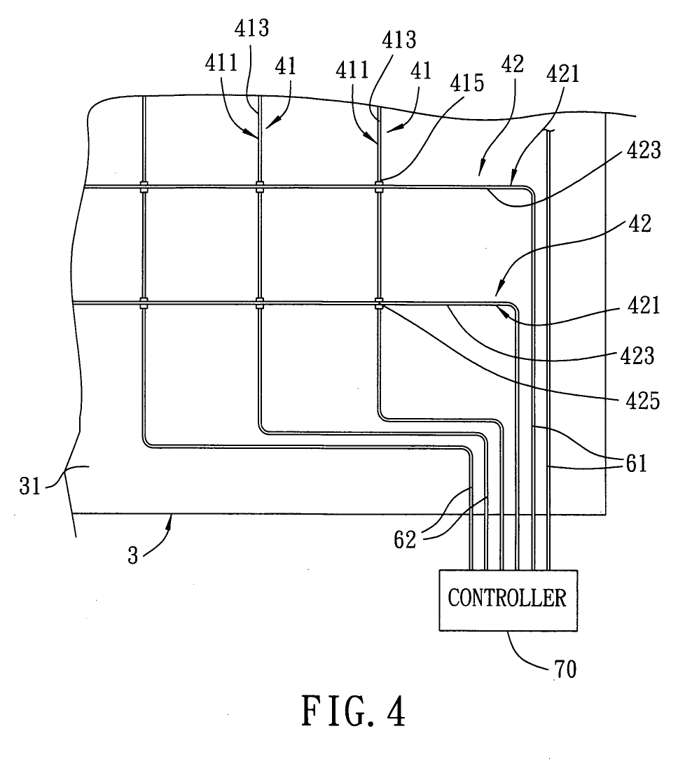

FIGS. 3 to 5 illustrate the first preferred embodiment of a capacitive-type touch panel for a liquid crystal display 80 according to this invention. The capacitive-type touch panel includes: a transparent substrate 3; a plurality of first conductors 41 disposed on the transparent substrate 3 and oriented in a first direction; a plurality of second conductors 42 disposed on the transparent substrate 3, oriented in a second direction transverse to the first direction, intersecting insulatively with the first conductors 41, and cooperating with the first conductors 41 to form a matrix of capacitive regions 4 when a current is applied to the first and second conductors 41, 42; and a controller 70 connected electrically to the first and second conductors 41, 42 through conductive connecting lines 61, 62 for detecting the capacitance of each of the capacitive regions 4. Each of the first conductors 41 is intersected and divided by the second conductors 42 into a series of first electrode sections 411. Each of the second conductors 42 is intersected and divided by the first conductors 41 into a series of second electrode sections 421. Each of the first and second electrode sections 411, 421 of the first and second conductors 41, 42 has a fine conductor line-constructed structure which is constructed from a fine line-shaped conductor having a dimension that permits the fine line-shaped conductor to be substantially not visible to the naked eye. Preferably, the fine line-shaped conductor has a layer thickness less than 250 angstroms, and more preferably, ranging from 10-50 angstroms so as to be transparent, or has a line width less than 200 microns so as to be substantially not visible to the naked eye. Preferably, the fine line-shaped conductor is made from a metallic material selected from the group consisting of Cu, Al, Au, Ag, Ni, Cr, Mo, and combinations thereof. Formation of the first and second conductors 41, 42 can be conducted using vapor deposition techniques. It is noted that the fine line-shaped conductor can be linear, curved or meandering in shape.

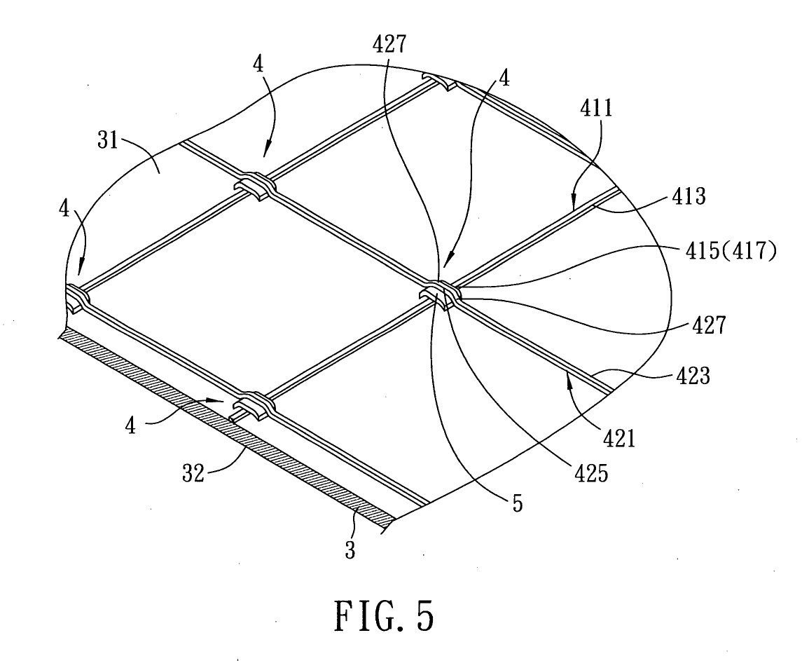

In this embodiment, each of the first and second electrode sections 411, 421 of the first and second conductors 41, 42 has a main part 413, 423 (see FIG. 5) that is linear in shape, and two opposite bridging parts 417 (427) extending from two opposite ends of the main part 413, 423 in opposite directions. Each of the bridging parts 417 of each of the first electrode sections 411 is connected to and cooperates with an adjacent one of the bridging parts 417 of an adjacent one of the first electrode sections 411 to define a first bridging line 415. Each of the bridging parts 427 of each of the second electrode sections 421 is connected to and cooperates with an adjacent one of the bridging parts 427 of an adjacent one of the second electrode sections 421 to define a second bridging line 425. The capacitive type touch panel further includes a plurality of spaced apart insulators 5, each of which is disposed at an intersection of the first bridging line 415 interconnecting the main parts 413 of an adjacent pair of the first electrode sections 411 and the second bridging line 425 interconnecting the main parts 423 of an adjacent pair of the second electrode sections 421, and each of which is sandwiched between the first bridging line 415 interconnecting the main parts 413 of the adjacent pair of the first electrode sections 411 and the second bridging line 425 interconnecting the main parts 423 of the adjacent pair of the second electrode sections 421.

In this embodiment, the transparent substrate 3 has opposite first and second surfaces 31, 32, and the first and second conductors 41, 42 are formed on the first surface 31 of the transparent substrate 3.

Preferably, the transparent substrate 3 is made from a material selected from the group consisting of glass, polymethylmethacrylate, polyvinylchloride, polypropylene, polyethylene terephthalate, polyethylene naphthalate, polycarbonate, and combinations thereof.

Preferably, each of the insulators 5 is made from a material selected from the group consisting of photoresist, silicon dioxide, titanium dioxide, zinc oxide, silicon nitride, aluminum nitride, tantalum oxide, and combinations thereof.

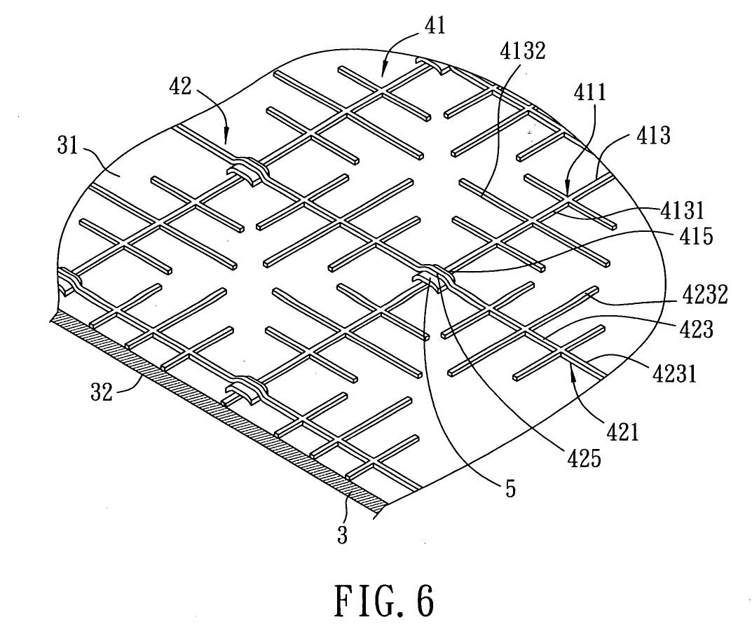

FIG. 6 illustrates the second preferred embodiment of the capacitive-type touch panel according to this invention. The second preferred embodiment differs from the previous embodiment in that the main part 413, 423 of the fine conductor line-constructed structure of each of the first and second electrode sections 411, 421 of the first and second conductors 41, 42 includes a linear stem portion 4131, 4231 and spaced apart linear branch portions 4132, 4232 transverse to the linear stem portion 4131, 4231.

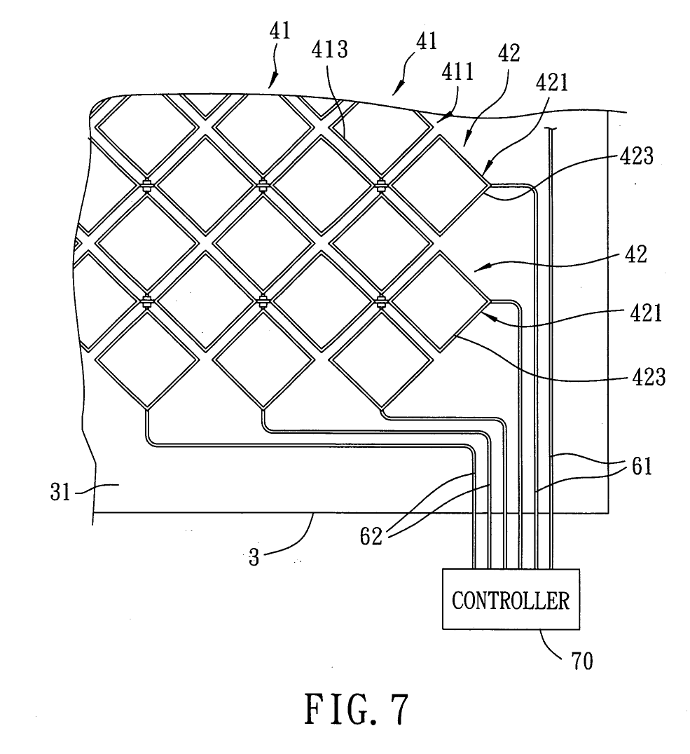

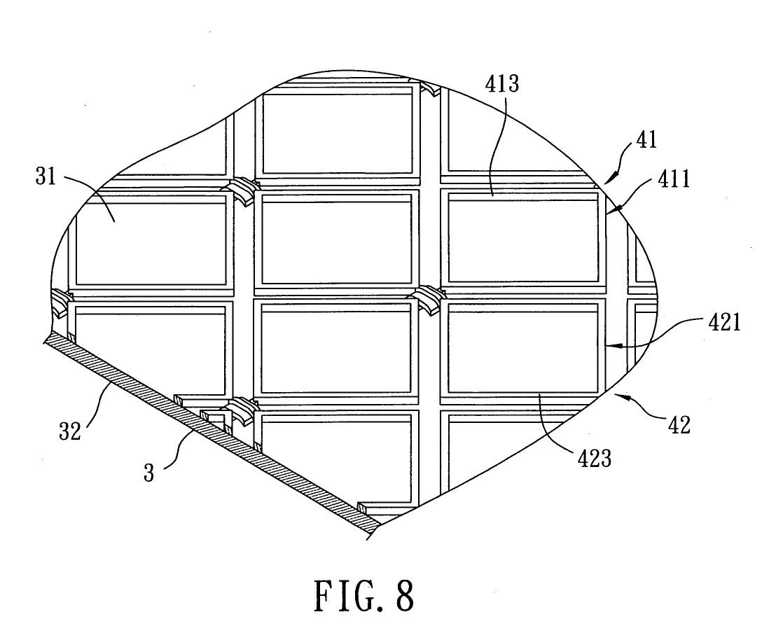

FIGS. 7 and 8 illustrate the third preferred embodiment of the capacitive-type touch panel according to this invention. The third preferred embodiment differs from the previous embodiments in that the main part 413, 423 of the fine conductor line-constructed structure of each of the first and second electrode sections 411, 421 of the first and second conductors 41, 42 is rectangular in shape.

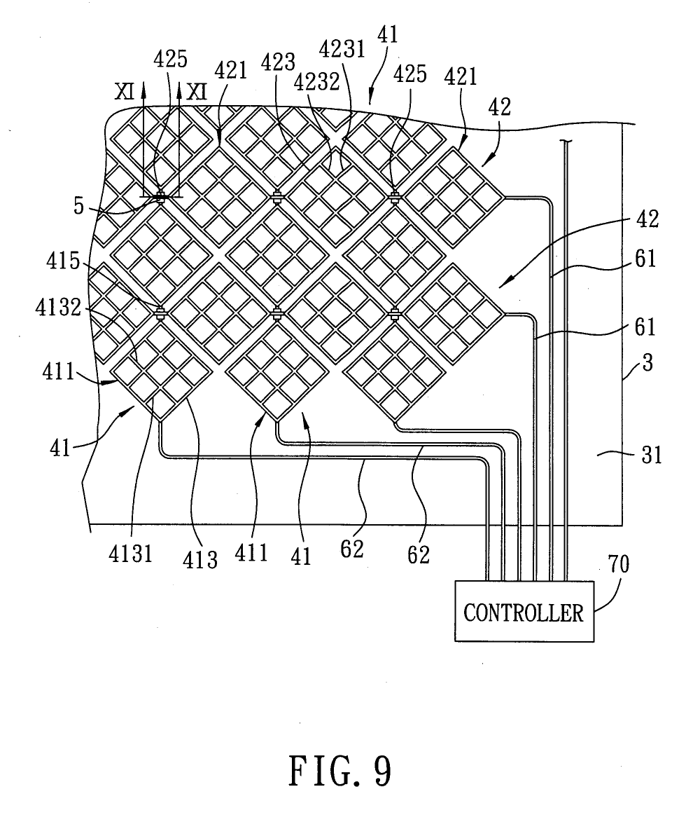

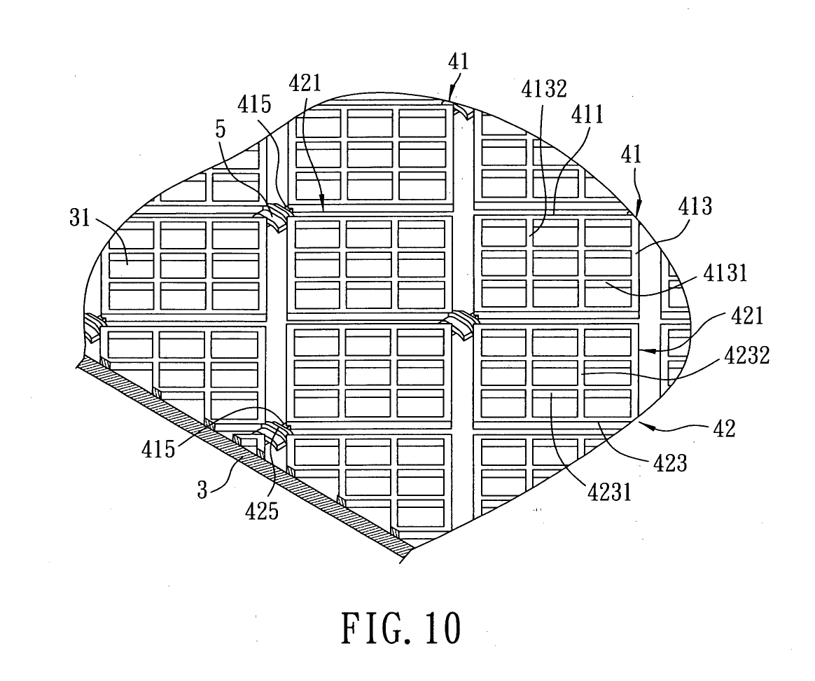

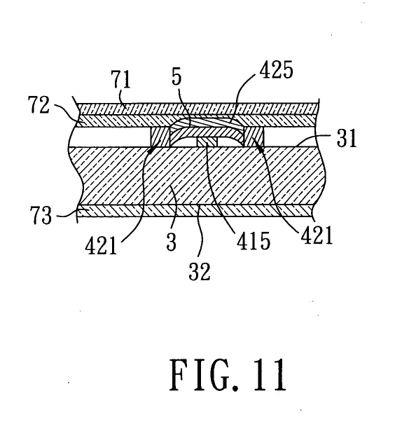

FIGS. 9 to 11 illustrate the fourth preferred embodiment of the capacitive-type touch panel according to this invention. The fourth preferred embodiment differs from the third preferred embodiment in that the main part 413, 423 of the fine conductor line-constructed structure of each of the first and second electrode sections 411, 421 of the first and second conductors 41, 42 has a screen-like shape. In this embodiment, the main part 413, 423 of the fine conductor line-constructed structure of each of the first and second electrode sections 411, 421 of the first and second conductors 41, 42 has a plurality of intersected weft and warp metal lines 4131, 4132 (4231, 4232). The capacitive-type touch panel of this invention further includes an anti-reflective layer 72 disposed on the first and second conductors 41, 42 (in this embodiment, it is formed directly on the first and second conductors 41, 42), a protective layer 71 disposed on the anti-reflective layer 72 (in this embodiment, it is formed directly on the anti-reflective layer 72), and a conductive layer 73 disposed on the second surface 32 of the transparent substrate 3 (in this embodiment, it is formed directly on the second surface 32 of the transparent substrate 3) and functioned as one of a grounding medium and an electromagnetically shielding medium. The conductive layer 73 is preferably made from a transparent conductive material. The screen-like structure permits enhancement in reduction of the sheet resistance of the capacitive-type touch panel. The protective layer 71 is preferably made from a material selected from the group consisting of adhesive, resin, photoresist, oxides, nitrides, and combinations thereof.

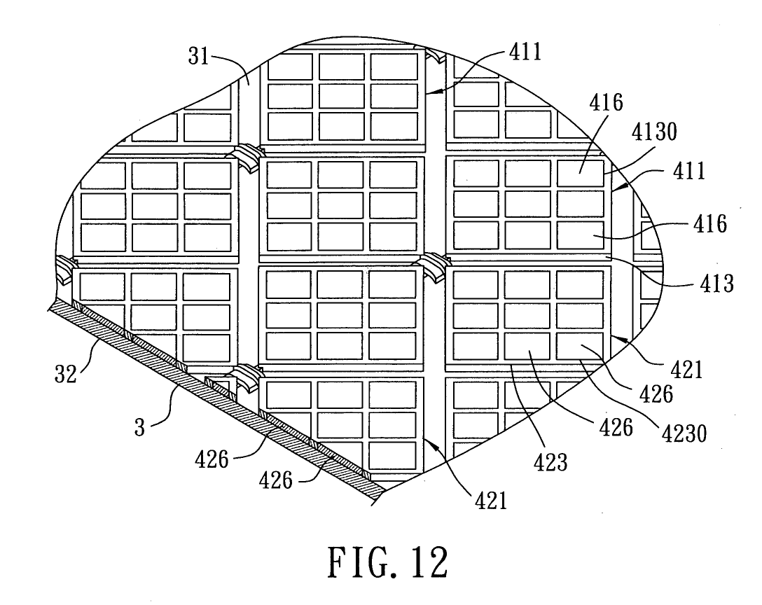

FIG. 12 illustrates the fifth preferred embodiment of the capacitive-type touch panel according to this invention. The fifth preferred embodiment differs from the fourth preferred embodiment in that the screen-like main part 413, 423 of the fine conductor line-constructed structure of each of the first and second electrode sections 411, 421 of the first and second conductors 41, 42 defines a plurality of holes 4130, 4230, each of which is filled with a transparent conductive material 416, 426. Preferably, the transparent conductive material 416, 426 is selected from the group consisting of indium-tin-oxide, indium-zinc-oxide, zinc oxide, aluminum zinc oxide, and combinations thereof. Inclusion of the transparent conductive material 416, 426 in the first and second conductors 41, 42 can enhance conductivities of the first and second conductors 41, 42 and increase sensing area so as to improve sensitivity of the capacitive-type touch panel.

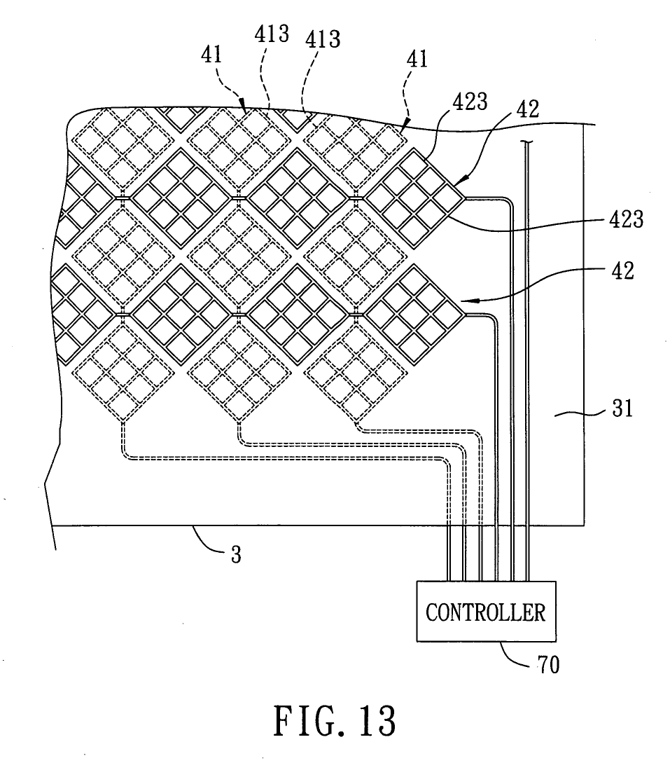

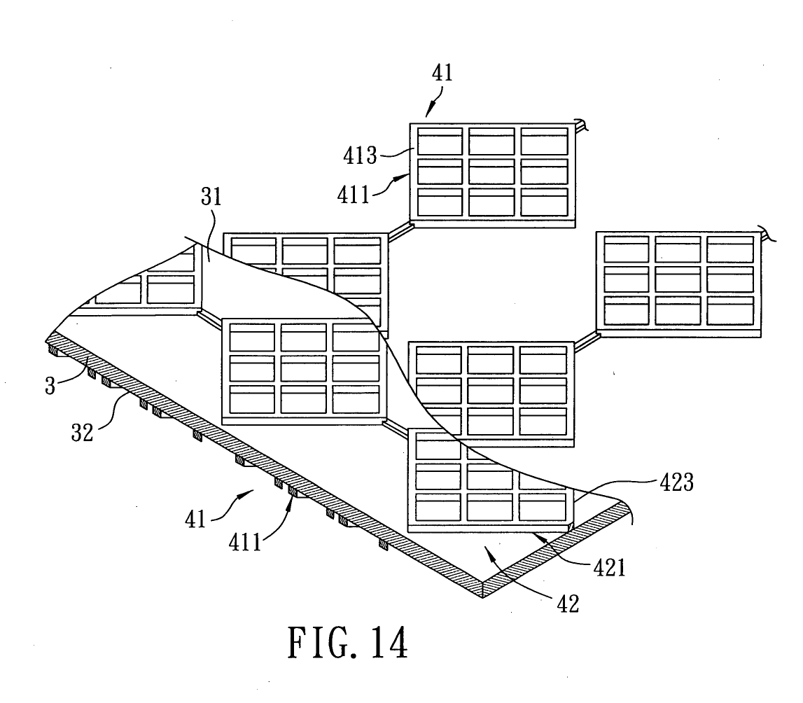

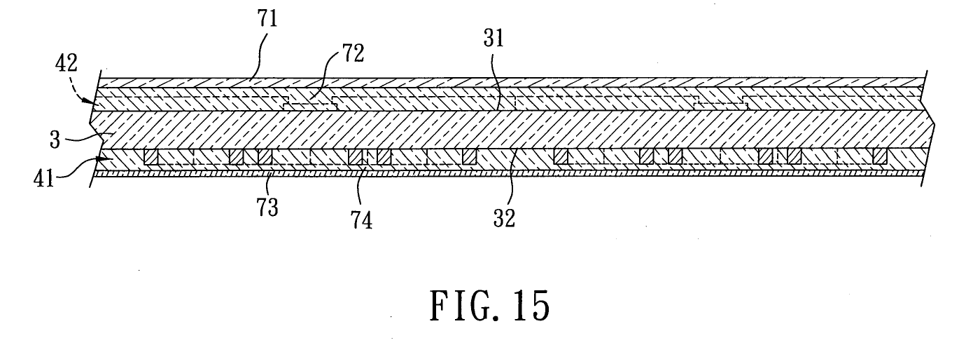

FIGS. 13 to 15 illustrate the sixth preferred embodiment of the capacitive-type touch panel according to this invention. The sixth preferred embodiment differs from the fourth preferred embodiment in that the first conductors 41 are formed on the second surface 32 of the transparent substrate 3, and the second conductors 42 are formed on the first surface 31 of the transparent substrate 3. An insulator layer 74 is disposed on the second surface 32 of the transparent substrate 3 (in this embodiment, it is formed directly on the second surface 32 of the transparent substrate 3). The conductive layer 73 is disposed on the insulator layer 74 (in this embodiment, it is formed directly on the insulator layer 74).

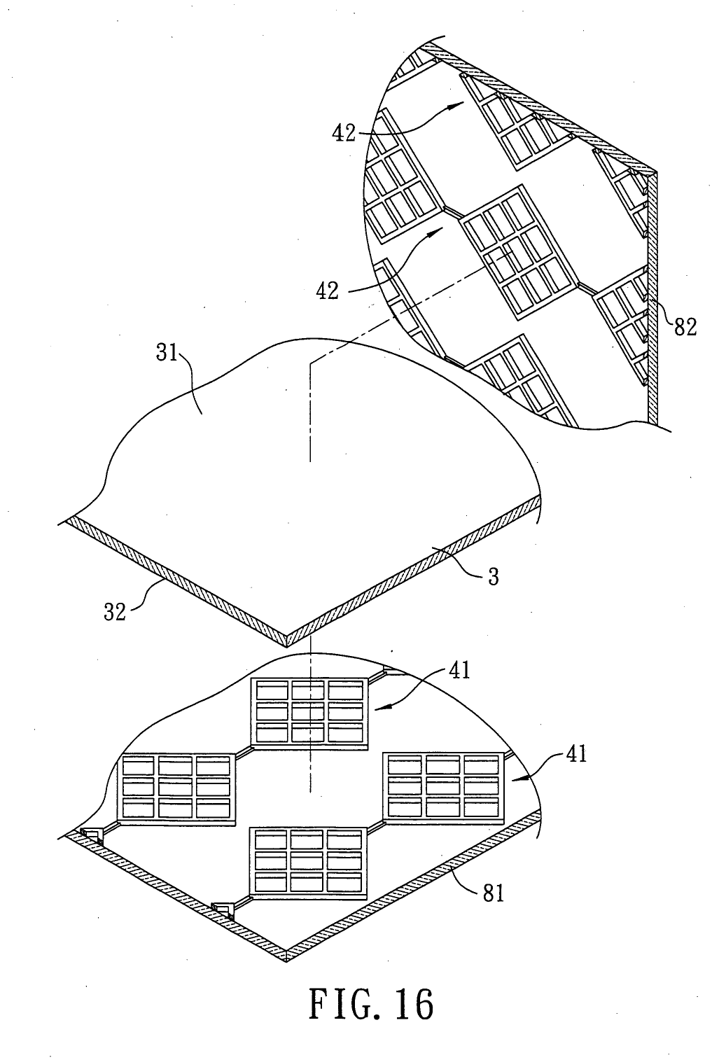

FIG. 16 illustrates the seventh preferred embodiment of the capacitive-type touch panel according to this invention. The seventh preferred embodiment differs from the fourth preferred embodiment in that the capacitive-type touch panel of this embodiment further includes first and second supporting substrates 81, 82 sandwiching the transparent substrate 3 therebetween, and that the first and second conductors 41, 42 are respectively formed on the first and second supporting substrates 81, 82. Preferably, the first and second supporting substrates 81, 82 are made from a material selected from the group consisting of glass, polymethylmethacrylate, polyvinylchloride, polypropylene, polyethylene terephthalate, polyethylene naphthalate, polycarbonate, adhesive, resin, photoresist, silicon dioxide, titanium dioxide, zinc oxide, silicon nitride, aluminum nitride, tantalum oxide, and combinations thereof.

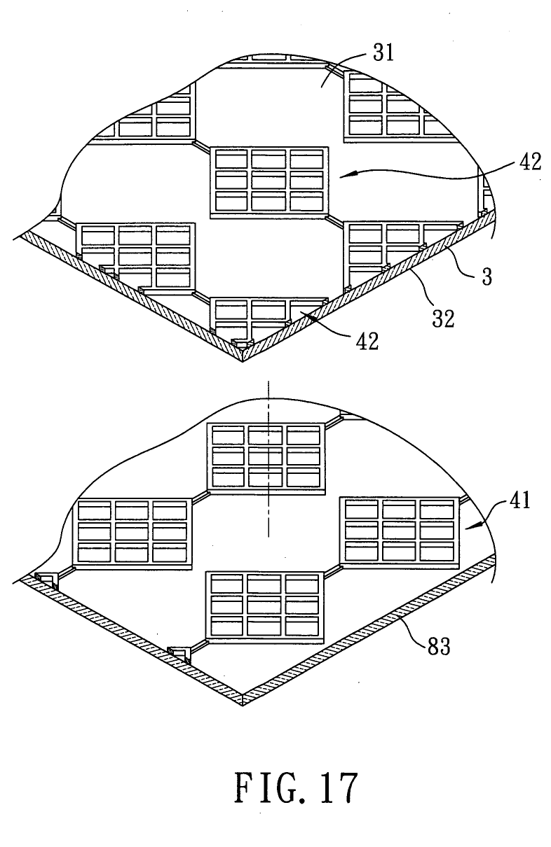

FIG. 17 illustrates the eighth preferred embodiment of the capacitive-type touch panel according to this invention. The eighth preferred embodiment differs from the fourth preferred embodiment in that the capacitive-type touch panel of this embodiment further includes a supporting substrate 83 attached to the second surface 32 of the transparent substrate 3. The first and second conductors 41, 42 are respectively formed on the first surface 31 of the transparent substrate 31 and the supporting substrate 83.

By virtue of the fine conductor line-constructed structure of each of the first and second electrode sections 411, 421 of the first and second conductors 41, 42 of the capacitive-type touch panel of this invention, the aforesaid drawbacks associated with the prior art can be eliminated, and the size of the capacitive-type touch panel of this invention can be enlarged as compared to the aforesaid conventional capacitive-type touch panels without exceeding the requirements in the sheet resistance and the capacitance from one peripheral end to an opposite peripheral end of the touch panel.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A capacitive-type touch panel comprising:
a transparent substrate;
a plurality of first conductors disposed on said transparent substrate;
a plurality of second conductors disposed on said transparent substrate intersecting insulatively with said first conductors, and cooperating with said first conductors to form a matrix of capacitive regions when a current is applied to said first and second conductors; and
a controller connected electrically to said first and second conductors for detecting the capacitance of each of said capacitive regions;
wherein each of said first conductors is intersected; and divided by said second conductors into a series of first electrode sections;
wherein each of said second conductors is intersected and divided by said first conductors into a series of second electrode sections; and
wherein each of said first and second electrode sections of said first and second conductors has a fine conductor line-constructed structure which is constructed from a fine line-shaped conductor.

2. The capacitive-type touch panel of claim 1, wherein said fine conductor line-constructed structure of each of said first and second electrode sections of said first and second conductors has a main part that is linear in shape.

3. The capacitive-type touch panel of claim 1, wherein said fine conductor line-constructed structure of each of said first and second electrode sections of said first and second conductors has a main part that includes a linear stem portion and spaced apart linear branch portions transverse to said linear stem portion.

4. The capacitive-type touch panel of claim 1, wherein said fine conductor line-constructed structure of each of said first and second electrode sections of said first and second conductors has a main part that is rectangular in shape.

5. The capacitive-type touch panel of claim 1, wherein said fine conductor line-constructed structure of each of said first and second electrode sections of said first and second conductors has a main part that has a screen-like shape.

6. The capacitive-type touch panel of claim 1, wherein said fine conductor line-constructed structure of each of said first and second electrode sections of said first and second conductors has a main part that has a screen-like shape and that defines a plurality of holes, each of which is filled with a transparent conductive material.

7. The capacitive-type touch panel of claim 6, wherein said transparent conductive material is selected from the group consisting of indium-tin-oxide, indium-zinc-oxide, zinc oxide, aluminum zinc oxide, and combinations thereof.

8. The capacitive-type touch panel of claim 1, wherein said fine line-shaped conductor has a layer thickness less than 250 angstroms.

9. The capacitive-type touch panel of claim 8, wherein said fine line-shaped conductor has a line width less than 200 microns.

10. The capacitive-type touch panel of claim 1, wherein said transparent substrate has two opposite surfaces, said first and second conductors being formed on one of said surfaces of said transparent substrate, each of said first and second electrode sections of said first and second conductors having a main part and two opposite bridging parts extending from said main part, each of said bridging parts of each of said first electrode sections being connected to and cooperating with an adjacent one of said bridging parts of an adjacent one of said first electrode sections to define a first bridging line, each of said bridging parts of each of said second electrode sections being connected to and cooperating with an adjacent one of said bridging parts of an adjacent one of said second electrode sections to define a second bridging line, said capacitive type touch panel further comprising a plurality of spaced apart insulators, each of which is disposed at an intersection of said first bridging line interconnecting said main parts of an adjacent pair of said first electrode sections and said second bridging line interconnecting said main parts of an adjacent pair of said second electrode sections, and each of which is sandwiched between said first bridging line interconnecting said main parts of the adjacent pair of said first electrode sections and said second bridging line interconnecting said main parts of the adjacent pair of said second electrode sections.

11. The capacitive-type touch panel of claim 10, wherein said insulator is made from a material selected from the group consisting of photoresist, silicon dioxide, titanium dioxide, zinc oxide, silicon nitride, aluminum nitride, tantalum oxide, and combinations thereof.

12. The capacitive-type touch panel of claim 1, wherein said transparent substrate is made from a material selected from the group consisting of glass, polymethylmethacrylate, polyvinylchloride, polypropylene, polyethylene terephthalate, polyethylene naphthalate, polycarbonate, and combinations thereof.

13. The capacitive-type touch panel of claim 1, wherein said transparent substrate has two opposite surfaces, said first and second conductors being respectively formed on said surfaces of said transparent substrate.

14. The capacitive-type touch panel of claim 1, wherein said transparent substrate has two opposite surfaces, said capacitive-type touch panel further comprising first and second supporting substrates sandwiching said transparent substrate therebetween, said first and second conductors being respectively formed on said first and second supporting substrates.

15. The capacitive-type touch panel of claim 14, wherein said first and second supporting substrates are made from a material selected from the group consisting of glass, polymethylmethacrylate, polyvinylchloride, polypropylene, polyethylene terephthalate, polyethylene naphthalate, polycarbonate, adhesive, resin, photoresist, silicon dioxide, titanium dioxide, zinc oxide, silicon nitride, aluminum nitride, tantalum oxide, and combinations thereof.

16. The capacitive-type touch panel of claim 1, wherein said transparent substrate has two opposite surfaces, said capacitive-type touch panel further comprising a supporting substrate attached to one of said surfaces of said transparent substrate, said first and second conductors being respectively formed on said supporting substrate and the other of said surfaces of said transparent substrate.

17. The capacitive-type touch panel of claim 16, wherein said supporting substrate is made from a material selected from the group consisting of glass, polymethylmethacrylate, polyvinylchloride, polypropylene, polyethylene terephthalate, polyethylene naphthalate, polycarbonate, adhesive, resin, photoresist, silicon dioxide, titanium dioxide, zinc oxide, silicon nitride, aluminum nitride, tantalum oxide, and combinations thereof.

18. The capacitive-type touch panel of claim 1, wherein said transparent substrate has two opposite surfaces, said capacitive-type touch panel further comprising a protective layer and a conductive layer that are respectively disposed on said surfaces of said transparent substrate, said conductive layer being made from a transparent conductive material and functioned as one of a grounding medium and an electromagnetically shielding medium.

19. The capacitive-type touch panel of claim 18, wherein said protective layer is made from a material selected from the group consisting of adhesive, resin, photoresist, oxides, nitrides, and combinations thereof.

20. The capacitive-type touch panel of claim 1, wherein said fine line-shaped conductor is made from a metallic material selected from the group consisting of Cu, Al, Au, Ag, Ni, Cr, Mo, and combinations thereof.

21. The capacitive-type touch panel of claim 1, wherein said fine line-shaped conductor has a dimension that permits said fine line-shaped conductor to be substantially not visible to the naked eye.
